(19) United States
(12) Patent Application Publication
(10) Pub. No.: US 2023/0191173 A1
(43) Pub. Date: Jun. 22, 2023

(54) System and Device for a deployable Wildfire Protection System

(71) Applicant: Larry Christie, Houston, TX (US)

(72) Inventor: Larry Christie, Houston, TX (US)

(21) Appl. No.: 17/557,006

(22) Filed: Dec. 20, 2021

(51) Int. Cl. A62C 3/02; A62C 27/00

(52) U.S. Cl. CPC A62C 3/0207; A62C 27/00

(57) ABSTRACT

The apparatus, system and method for the suppression and containment of wildfires is provided. The system can be designed as a mobile or a stationary containment system. Each system is operationally connected to a fan assembly that is in fluidic communications with a reservoir tank that is mounted within each, containment system. In one important aspect of the present invention each fan assembly can be customized and engineered to contain the associated wildfire environment.

### BACKGROUND OF THE INVENTION

This invention relates to deployable Wildfire Protection Systems. Throughout North America, wildfires are becoming more increasingly devasting. It has become increasingly impossible to stop the domino effect of trees, homes and flying embers igniting and destroying entire communities.

Uncontrolled fires have especially damaged farm and ranch operators effecting the food supply chain in America. Additionally, wildfires can cause pollution in the affected areas. This system is an alternative method and system of deploying a fire prevention system to support wildfires threatening entire communities.

### SUMMARY OF THE INVENTION

The Wildfire Protection and Containment System in its preferred embodiment, is a self-contained deployable wildfire protection and containment system that can be deployed by first responders. The new invention provides first responders with a cost effective tool to protect villages, towns, cities or rural communities adjacent to wild land urban interface environments through a method or technique.

The apparatus, system and method for the suppression and containment of wildfires is provided. The system can be designed as a mobile or a stationary containment system. Each system is operationally connected to a fan assembly that is in fluidic communications with a reservoir tank that is mounted within each, containment system. In one important aspect of the present invention each fan assembly can be customized and engineered to contain the associated wildfire environment.

The system design and goal are to provide protection to building structures of up to 10 stories or more. Additionally, the system incorporates technology that transmits data from the fire zone to a remote and/or local command center via onboard sensors, monitors, cameras, satellite imaging technology, GPS, and other wireless devices.

The system can be fitted with nozzles that can discharge higher volumes of water towards up toward a top capacity of 1000 gallons per minute per nozzle. To achieve this kind of volume would incorporate a series of portable high pressure and high-volume pumps that can transfer from large water points such as reservoirs, lakes, ponds, and rivers etc. Booster windmill pumps can be utilized to push water over long distances and help to maintain desired pressures at the water nozzles incorporated into the fan assembly.

Additionally, the system can be set up to provide a mist moisture in the air to prevent the movement of wildfires by providing constant moisture within the atmosphere.

The system comprises a wildfire protection and containment method, and sensory capture system to assist first responders the tools to prevent and control the spread of wildfires.

The containment system can protect an entire subdivision, township or city, by strategically placing multiple mobile or stationary fan assembly containment systems at multiple locations working simultaneously to cut the fire off at multiple locations using a pre-planned process which incorporates remote and local command and control in communications with satellite imaging and other communications technology.

This method is a practical and safe method of providing an effective protection and containment solution removing fire fighters from the most dangerous areas of the wildfire zone.

One of the major purposes is to provide a safer method of protecting homes and building structures in an entire subdivision bordering wild land urban interface environments from wildfire. While allowing fire fighters to operate the system to their advantage and remain at a safe distance from the affected wildfire zone.

The above and other objects, features and advantages of the present invention should become even more readily apparent to those skilled in the art upon a read in of the following detailed description in conjunction with the drawings wherein there is shown and described illustrative embodiments of the invention.

### BRIEF DESCRIPTION OF DRAWINGS

These and other details of the present invention will be described in connection with the accompanying drawings, which are not furnished only by way of illustration and not in limitation of the invention.

FIG. 1 depicts perspective view of the present invention, wildfire containment system.

FIG. 1a depicts a perspective view of the tank on stabilizers.

FIG. 2 depicts perspective view of the mobile tanks with stabilizers.

FIG. 3 depicts perspective view of a horizontal mobile tank system.

FIG. 3a depicts a cutaway view of a nozzle of the horizontal mobile tank system.

FIG. 4 depicts cutaway view of motor and fan belt

FIG. 5 depicts cross sectional view of the nozzle.

FIG. 6 depicts cross sectional view of the motor and fan belt.

FIG. 7 depicts cutaway view of the crane assembly.

FIG. 8 depicts perspective view of the stationary system.

FIG. 8a depicts perspective view of the telescoping system.

FIG. 9 depicts cutaway view of the hose assembly.

FIG. 10 depicts perspective connected view of the mobile system.

FIG. 11 depicts reservoir tank irrigation system.

FIG. 12 depicts mobile system implemented in a subdivision.

FIG. 13 illustrates a sample control center for the invention.

FIG. 14 is a cross-section of the nozzle.

FIG. 15 is a frontal cross-section of the nozzle.

### DETAILED DESCRIPTION

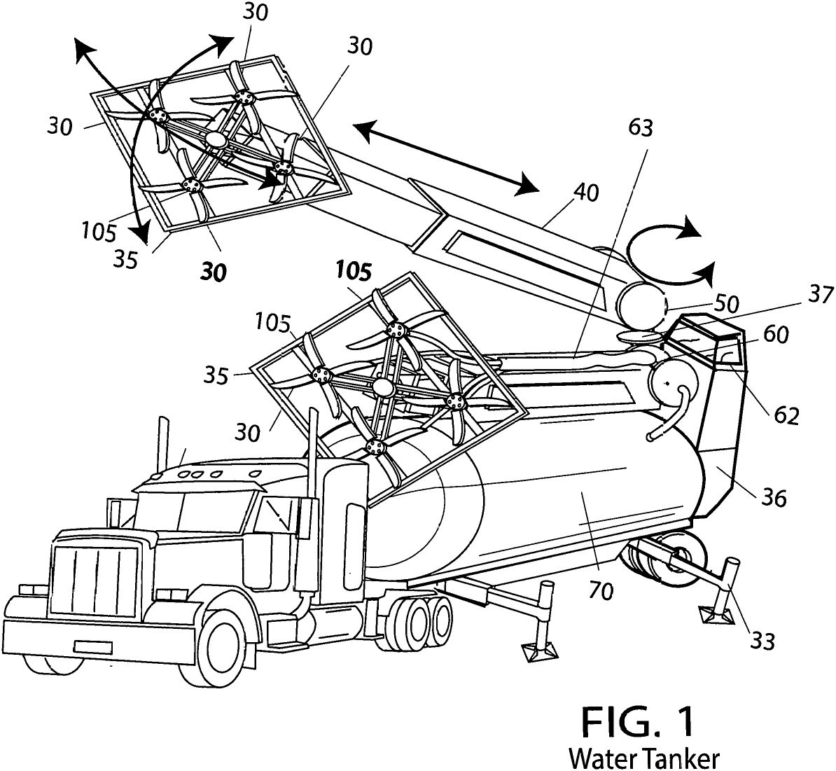

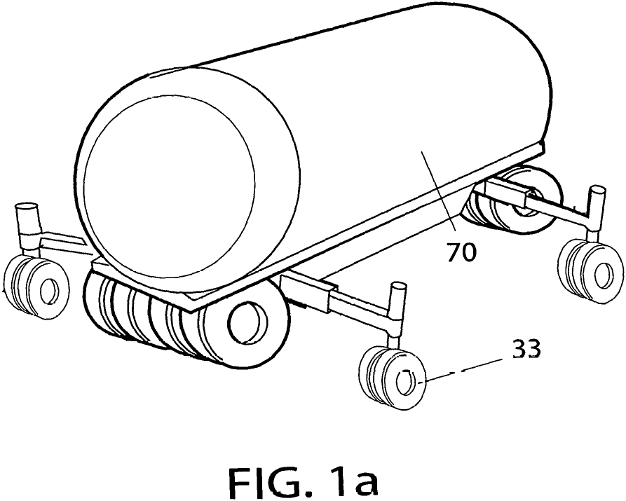

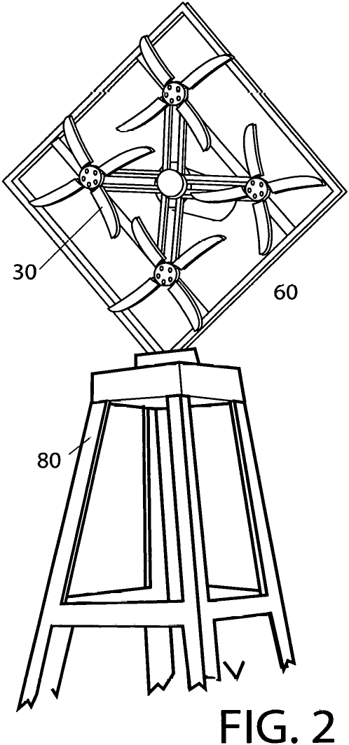

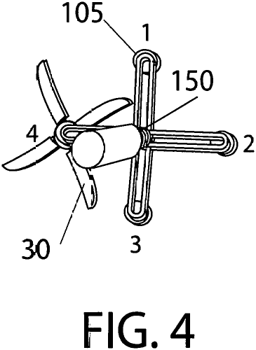

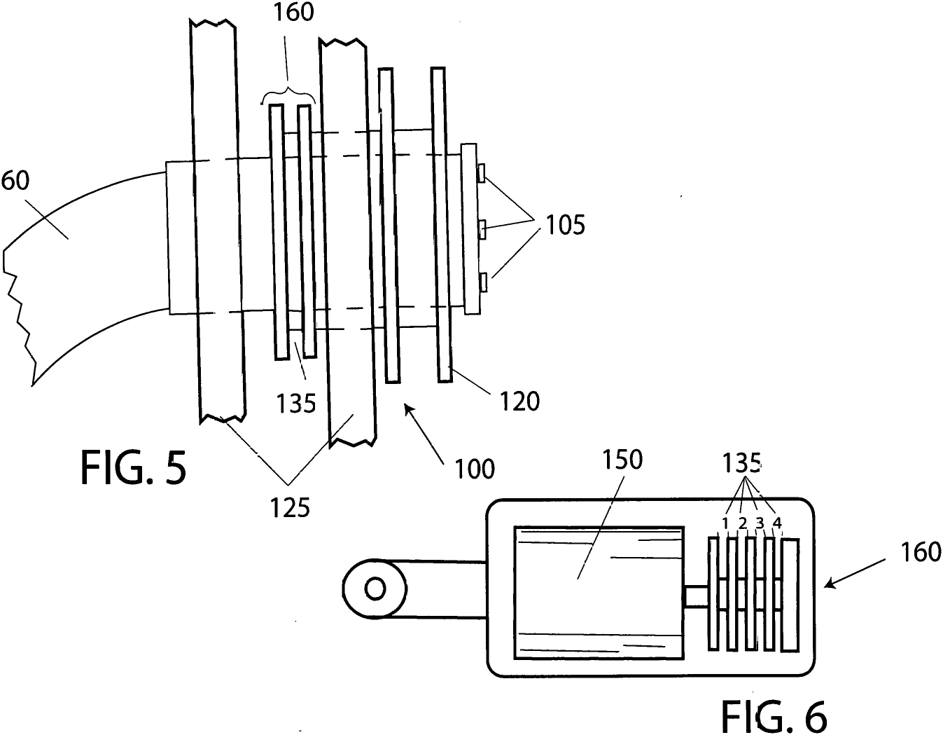

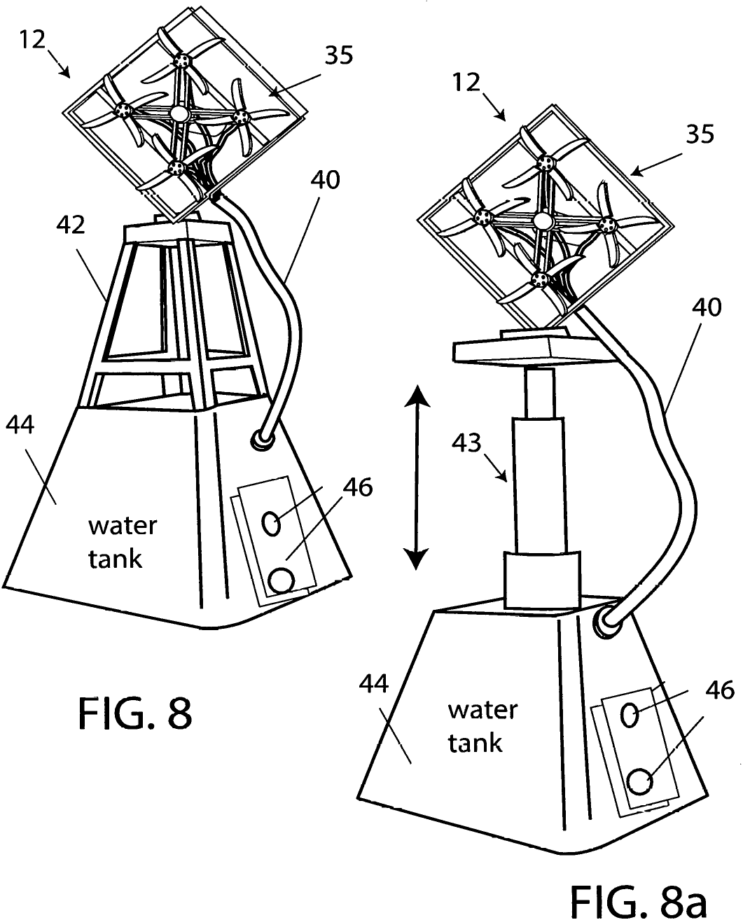

The fire containment system and method of the present invention comprises a mobile embodiment system and tower embodiment system. The mobile embodiment system is disclosed in FIG. 1 and the tower embodiment system is disclosed in FIGS. 2, 8, and 8a. Both systems interfaces and is in fluidic communications with a common fan assembly design as depicted in FIGS. 4, 5, and 6.

The mobile embodiment system comprises a semi-trailer platform that supports a reservoir tank that is in fluidic communication with a fan assembly. A command center and a crane assembly are operationally connected to the semi-trailer platform.

The tower embodiment system comprises a stationary platform elevated at least 5 feet above the ground. The stationary platform supports a fan assembly that is in fluidic communication with a reservoir tank which can be incorporated into the tower or setup separately from the tower.

The semi-trailer platform consists of a flat-bed trailer without a front axle but has a detachable front dolly which attaches to a truck for moving the semi-trailer platform to other locations. In some embodiments a fifth wheel assembly is used to provide a link between the trailer and the hauling truck. The semi-trailer is equipped with wheels and stabilizing landing gear that is lowered when the semi-trailer platform is decoupled. The stabilizing landing gear can alternatively have wheels which allow the semi-trailer platform the ability to move to alternative locations when decouples.

The reservoir tanks contain the liquids that is in fluidic communication with the fan assembly. In the preferred embodiments the transported tanks are horizontally cylindrical in shape and can extend the length of the semi-trailer platform. Because the horizontal tank has a low profile, creates a center of gravity that helps to maintain an equilibrium during transportation. However, vertical tanks are normally used to store stationary reservoirs. However, the reservoir tanks can have other shapes including vertically cylindrical. As depicted the reservoir tank is disposed upon the flat-bed trailer. Additionally, the reservoir tank needs to be configured to prevent water from becoming flat and contaminated. The reservoir tank is normally pressurized and then pumped into the distribution system. Additionally, the tank needs to be monitored for bacteria, viruses, and changes in PH due to storage. The storage tank can be made of plastic material, metal material or another suitable material.

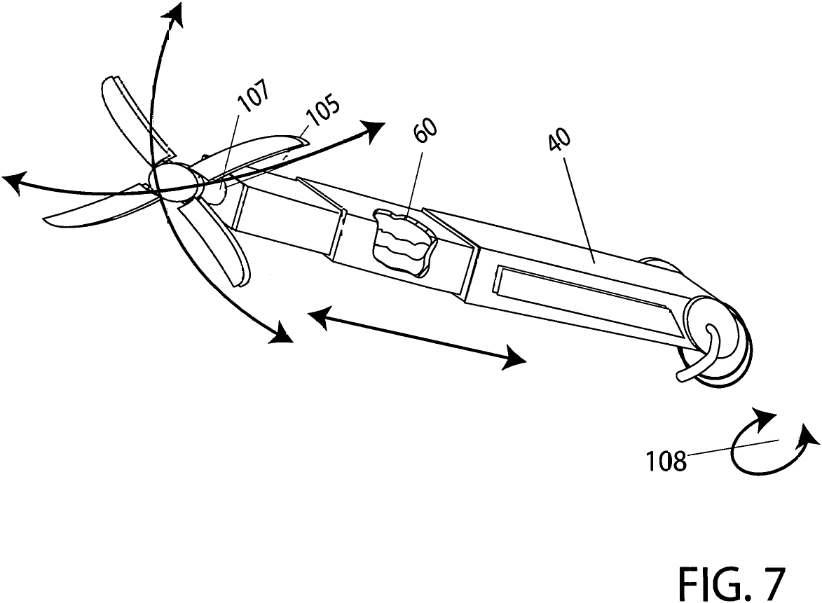

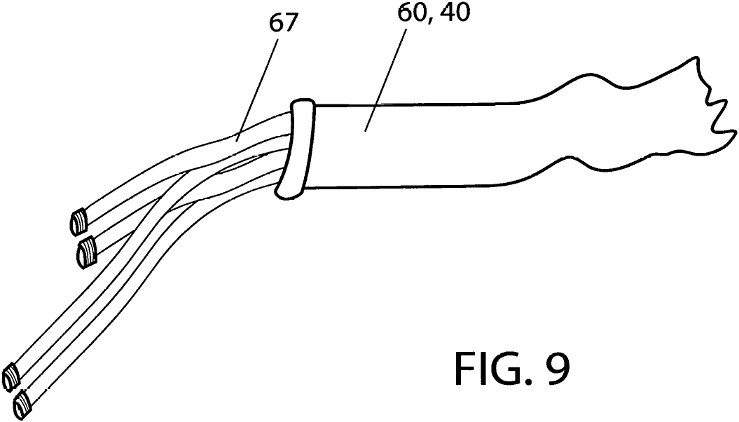

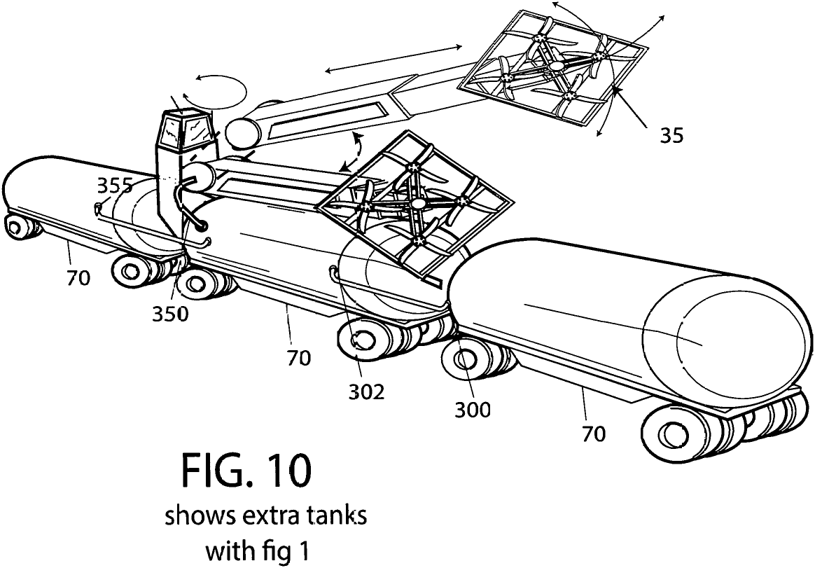

A hose assembly as depicted in FIGS. 7 and 9 provides the fluidic communication between the reservoir tank and the fan assembly. As depicted multiple hoses can be incorporated into one elongated pipe extending from the reservoir tank to the fan assembly. In the depicted embodiment one hose can be operationally coupled to one or more nozzles.

Command Center is used to control the movement of the crane assembly and the emission of the fluid from the nozzles located in the fan assembly. The command center is disposed near the lower end of the crane assembly upon the trailer platform. The command center can be hands on or remotely controlled. The command center can be in communications with a remote center that is providing remote communications to control the crane and fan assembly to remotely contain the fire prior to sending first responders. The command center communicates with satellite’s and GPS to effectively determine where and when to deploy different systems during a wildfire.

As depicted the mobile system further comprises a trailer mounted crane assembly. The crane assembly is defined by a lower end, upper end, top portion, and lower portion. The lower end of the crane assembly is rotationally and pivotally coupled to the semi-trailer platform. The lower portion and the upper portion of the crane assembly is telescopically coupled to allow the crane assembly to access multiple heights during a wildfire. A pivot ball bearing is operationally coupled between the upper end of the crane assembly and the fan assembly thereby allowing the fan assembly the ability to rotate and pivot as required to contain a wildfire.

The frame assembly comprises a support frame, motor, fly wheel, and nozzles. The support frame has an outer perimeter with internally mounted vertical and/or horizontal support beans. The support frame can be made of wood, plastic, metal, or another suitable material. The fly wheel is operationally couple to the front of the motor with both centrally mounted within the support frame. In the illustrated embodiment, a plurality of nozzles encircles the fly wheel wherein each nozzle is operationally coupled to the fly wheel by a fan belt. Each nozzle has a plurality of jet streams that emits water directly onto the fire or by misting moisture into the atmosphere. Alternatively, with the stationary embodiment a pivot ball bearing is mounted to the fan assembly to allow the rotationally and pivotally movement of the fan assembly.

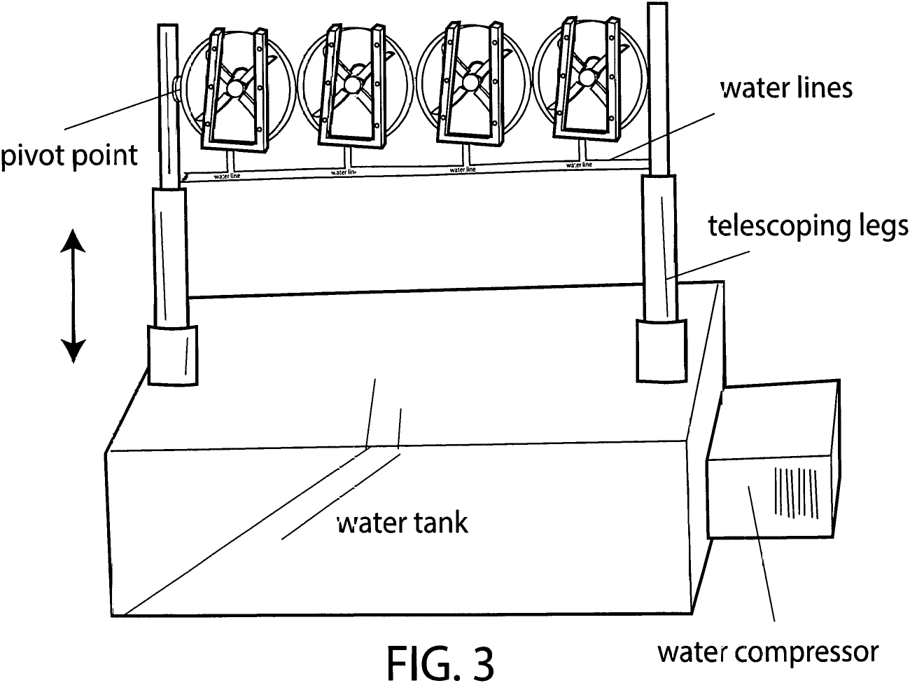

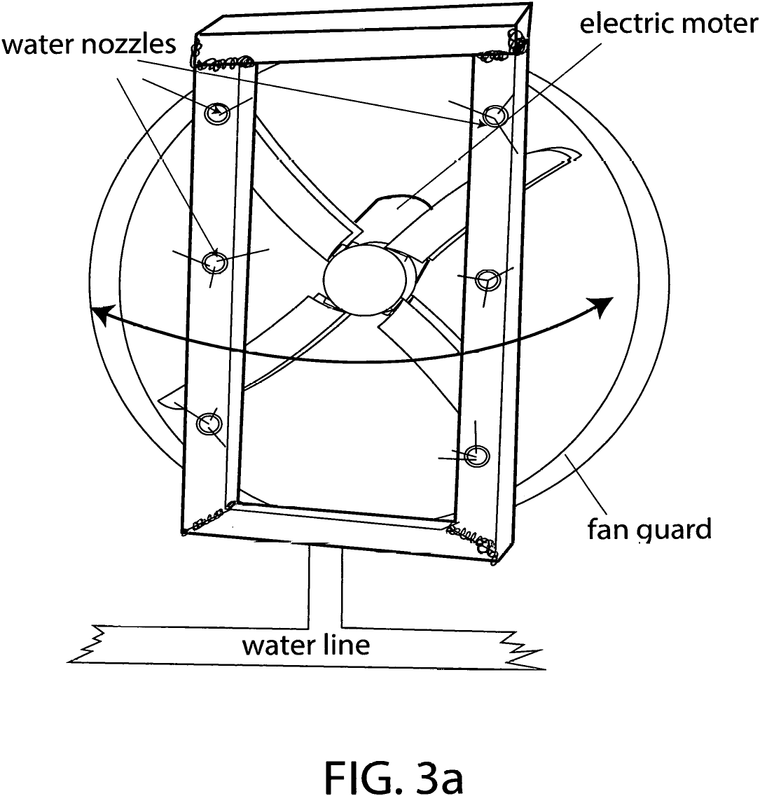

Alternatively, as depicted in FIGS. 3 and 3a, the fan assembly can be designed to be horizontally and perpendicular to a horizontal reservoir tank. In this embodiment, a support beam is mounted above and in a parallel arrangement to the horizontal reservoir tank. A plurality of nozzles are operationally coupled to the support beam along its longitudinal axis. The support beam can be telescopically and/or pivotally mounted to the reservoir tank. con

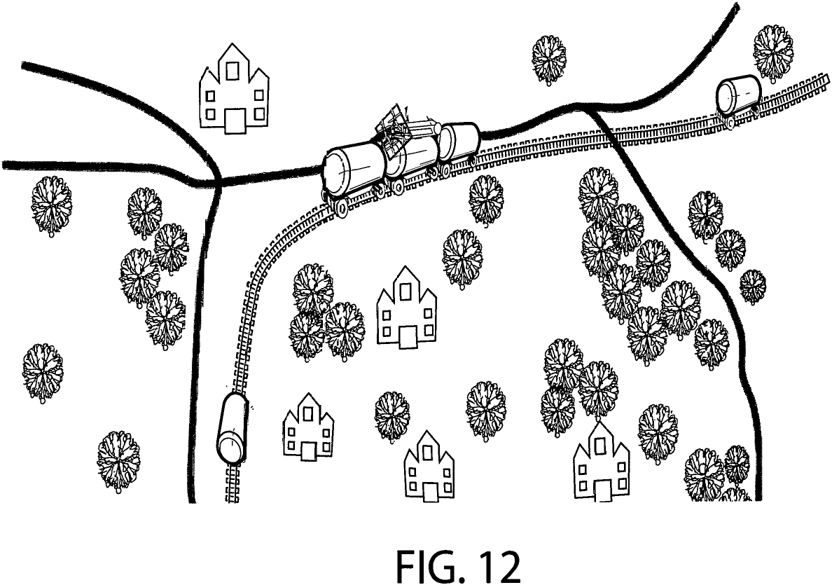

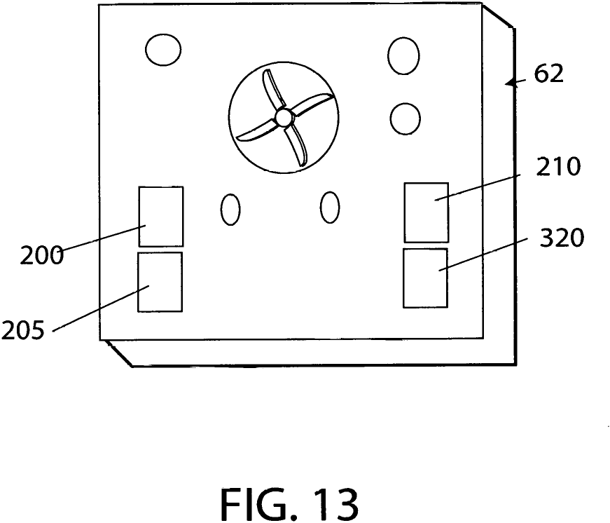

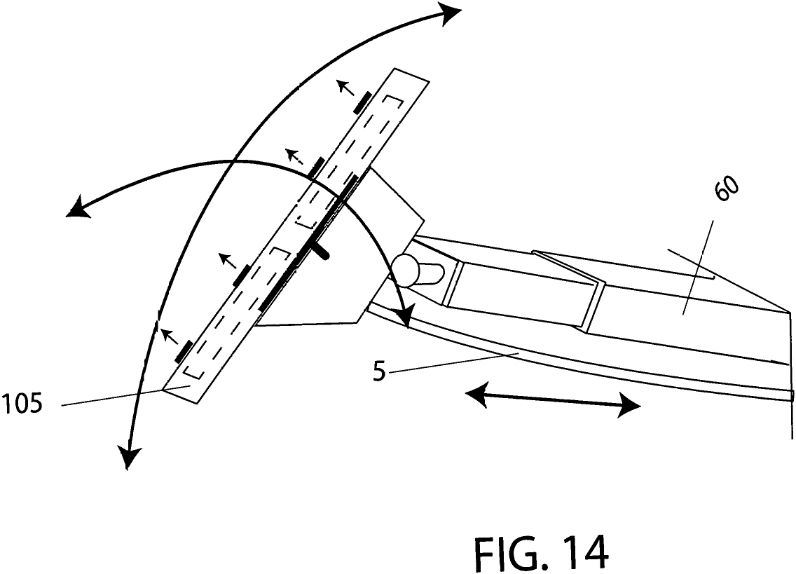

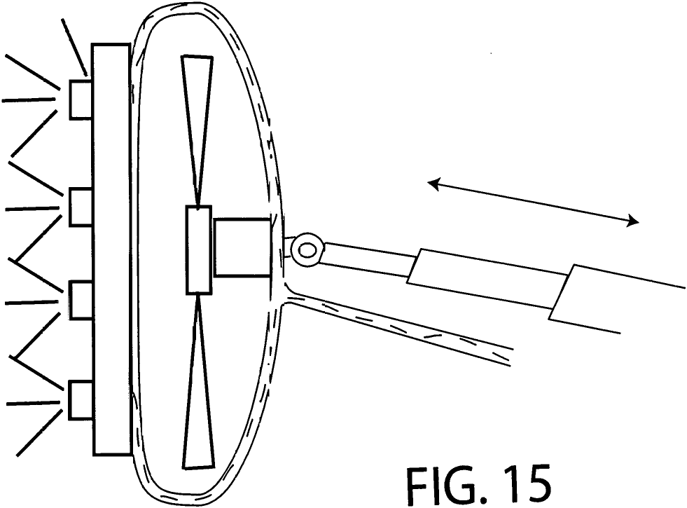

FIG. 12 illustrates the fire containment system adapted to support a community. As depicted multiple reservoir tanks are coupled together as the customized system can be transported along a track strategically placed within the community.

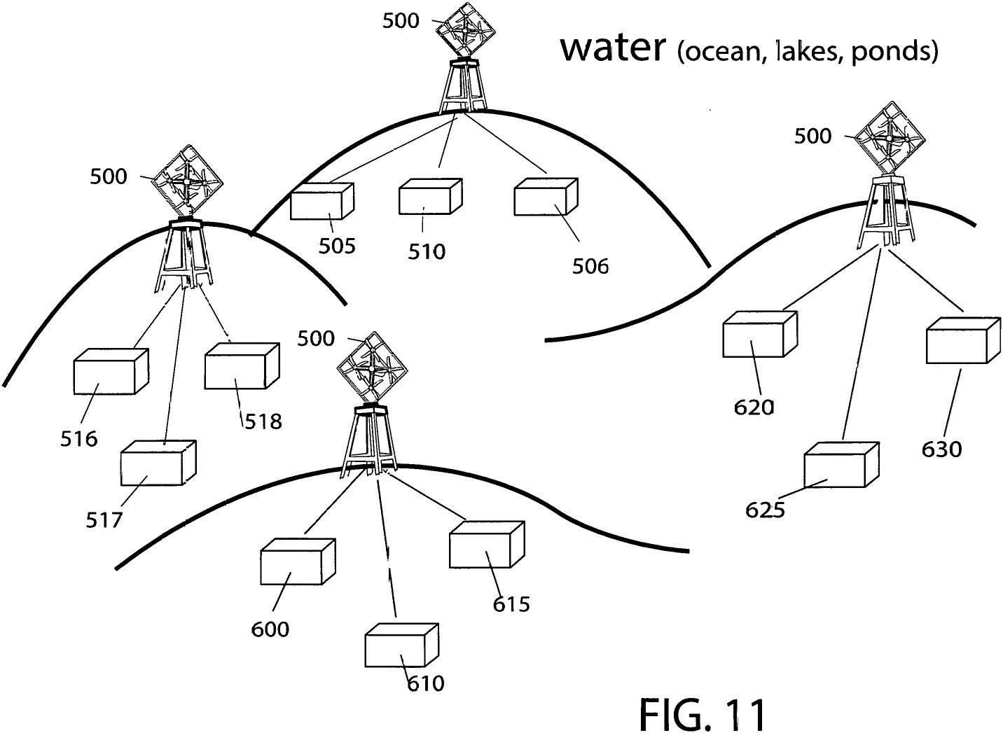

FIG. 11 illustrates the irrigation of the water to the reservoir tanks that are part of a mobile or a stationary system. Water is pumped from ponds, lakes, rivers, or larger collection reservoir tanks to fire containment systems strategically deployed within various communities.

As depicted in FIG. 12, a mobile containment system would be customized to support an environment. The pre-determined reservoir tanks would be stored and interconnected. Once a pre-staging plan has been created the fire fighters would begin to deploy system by connecting mobile tanks. With stationary tanks, enough would need to set up to support an environment based upon past wildfires. FIG. 1 connects to the next 1 by a predetermined length of fire hose. Enough tanks would need to be interconnected to effectively create a containment barrier within a subdivision.

What is claimed is:

1. A fire containment system comprising: a fan assembly operationally mounted within a support frame; the fan assembly has a plurality of nozzles operationally coupled thereon; the fan assembly is operationally coupled to a pivot ball bearing; the fan assembly is in fluidic communication with a reservoir tank.

2. The fire containment system of claim 1 wherein the reservoir tank is mounted upon a mobile semi-trailer platform.

3. The fire containment system of claim 1 wherein the reservoir tank is mounted upon an elevated tower above ground level.

4. The fire containment system of claim 2 further comprising a crane assembly operationally coupled to the mobile semi-trailer platform.
